(19) United States
(12) Patent Application Publication
(10) Pub. No.: US 2012/0022416 A1
(43) Pub. Date: Jan. 26, 2012

(54) LEG CONSTRICTION APPARATUS FOR PROMOTING BLOOD CIRCULATION

(76) Inventor: Emilio A. Munoz, Naples, FL (US)

(21) Appl. No.: 12/842,060

(22) Filed: Jul. 23, 2010

(51) Int. Cl. A61H 7/00

(52) U.S. Cl. 601/152

(57) ABSTRACT

A mobile leg constriction apparatus for promoting blood circulation is disclosed. The leg constriction apparatus includes a first cylindrically-shaped inflatable element for surrounding a patient's thigh, a second cylindrically-shaped inflatable element for surrounding the patient's calf, a first tube for connecting the first inflatable elements to an air pump and a second tube for connecting the second inflatable elements to the air pump. The leg constriction apparatus further includes an enclosure comprising an air pump for inflating the first and second inflatable elements. The leg constriction apparatus further includes one or more pressure sensors for measuring air pressure within the first and second tubes, one or more escape valves for allowing air to escape from the first and tubes and a processor configured for receiving information from the one or more pressure sensors and initiating inflation and deflation of the first and second inflatable elements according to a predefined profile.

### CROSS-REFERENCE TO RELATED APPLICATIONS

Not Applicable.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### FIELD OF THE INVENTION

The invention disclosed broadly relates to the field of medical devices, and more particularly relates to the field of medical devices for promoting the circulation of blood in an individual.

### BACKGROUND OF THE INVENTION

With the increasing incidence of diabetes and obesity in society today, blood circulation problems have been commonplace in the health care field. Circulatory problems of this type are caused by a variety of sources, including circulatory valve insufficiency. Various side affects to poor circulation are observed, including pooling of blood in a patient's legs and necrosis of appendages. One approach to solving the problem of poor circulation involves the use of inflatable elements that surround a patient's limb, such as his legs, to push blood out of this area of the patient's legs and into another area. This approach, however, comes with drawbacks.

Conventional devices for aiding blood circulation in patients with circulatory problems in their legs can be large and bulky. U.S. Pat. No. 3,303,841 and U.S. Pat. No. 3,465,748 are examples of such conventional devices that comprise hefty devices constructed mainly for a patient in a hospital or otherwise not ambulatory. Though these devices may provide some circulatory aid, they do not satisfy the desire of users to move or work while using such devices. Therefore, the large and unwieldy nature of conventional circulatory aid devices limits their versatility and use.

Further, conventional devices for aiding blood circulation in patients often comprise a large number of inflatable compartments that surround a patient's limb. U.S. Pat. No. 4,590,925 is an example of such a device that comprises an inordinate number of inflatable elements. The high number of inflatable elements in these types of devices results in an elevated number of mechanical parts, thereby increasing the complexity of the mechanical system and the probability of failure or malfunction of the system. Further, the numerous inflatable elements restrain the movement of the patient, thereby inhibiting the ability of a patient to be productive while using such conventional devices. Thus, the large number of inflatable elements of conventional circulatory aid devices limits their usability.

Lastly, the bulky nature of conventional devices for aiding blood circulation do not allow for discrete use by patients. In addition to the bulky nature of these devices, and the high number of inflatable elements that do not allow the apparatus to be hidden, the devices can be loud, thereby making it obvious to bystanders that the patient is using such as device. As there

[symbol]

Therefore, a need exists to overcome the problems with the prior art as discussed above, and particularly for a blood circulation aid that is user-friendly, discrete and allows freedom of movement.

### SUMMARY OF THE INVENTION

Briefly, according to an embodiment of the present invention, a mobile leg constriction apparatus for promoting blood circulation is disclosed. The leg constriction apparatus includes a first cylindrically-shaped inflatable element for surrounding a patient's thigh, a second cylindrically-shaped inflatable element for surrounding the patient's calf, a first tube for connecting the first inflatable elements to an air pump and a second tube for connecting the second inflatable elements to the air pump. The leg constriction apparatus further includes a palm-sized enclosure comprising an air pump for inflating the first and second inflatable elements up to a predefined maximum pressure, wherein the air pump is coupled to the one or more tubes. The leg constriction apparatus further includes one or more pressure sensors for measuring air pressure within the first and second tubes, one or more escape valves for allowing air to escape from the first and tubes and a processor communicatively coupled to the air pump, the one or more pressure sensors and the one or more escape valves, and configured for receiving information from the one or more pressure sensors and initiating inflation and deflation of the first and second inflatable elements according to a predefined profile.

In an alternative embodiment of the present invention, a mobile leg constriction apparatus for promoting blood circulation includes a pair of pants having a first and second pant leg and wherein each pant leg includes a thigh portion and a calf portion. The apparatus further includes a first cylindrically-shaped inflatable element coupled to an interior of the thigh portion of a first pant leg, wherein the first inflatable element surrounds a patient's thigh and a second cylindrically-shaped inflatable element coupled to an interior of the calf portion of the first pant leg, wherein the second inflatable element surrounds the patient's calf. The apparatus further includes a first tube for connecting the first inflatable element to an air pump, wherein the first tube is located behind an exterior seam of the pair of pants and a second tube for connecting the second inflatable element to the air pump, wherein the second tube is located behind an exterior seam of the pair of pants. The apparatus further includes a palm-sized enclosure comprising an air pump for inflating the first and second inflatable elements up to a predefined maximum pressure, wherein the air pump is coupled to the first and second tubes, one or more pressure sensors for measuring air pressure within the first and second tubes, one or more escape valves for allowing air to escape from the first and second tubes, and a processor communicatively coupled to the air pump, the one or more pressure sensors and the one or more escape valves, and configured for receiving information from the one or more pressure sensors and initiating the inflation and deflation of the first and second inflatable elements according to a predefined profile.

The foregoing and other features and advantages of the present invention will be apparent from the following more particular description of the preferred embodiments of the invention, as illustrated in the accompanying drawings.

### BRIEF DESCRIPTION OF THE DRAWINGS

The subject matter, which is regarded as the invention, is particularly pointed out and distinctly claimed in the claims at the conclusion of the specification. The foregoing and other features and also the advantages of the invention will be apparent from the following detailed description taken in conjunction with the accompanying drawings. Additionally, the left-most digit of a reference number identifies the drawing in which the reference number first appears.

FIG. 1 is an illustration of a perspective view of the leg constriction apparatus for promoting blood circulation, in accordance with one embodiment of the present invention.

FIG. 2 is an illustration of a perspective view of another embodiment of a leg constriction apparatus for promoting blood circulation, in accordance with one embodiment of the present invention.

FIG. 3 is an illustration of a more detailed view of the leg constriction apparatus for promoting blood circulation of FIG. 2.

FIG. 4 is an illustration of a transverse cross section view of another embodiment of a leg constriction apparatus for promoting blood circulation, in accordance with one embodiment of the present invention.

FIG. 5 is an illustration of a block diagram of the main electrical and mechanical components of the leg constriction apparatus for promoting blood circulation, in accordance with one embodiment of the present invention.

FIG. 6 is an illustration of a graph that charts pressure versus time with regard to the process of the leg constriction apparatus for promoting blood circulation, in accordance with one embodiment of the present invention.

### DETAILED DESCRIPTION

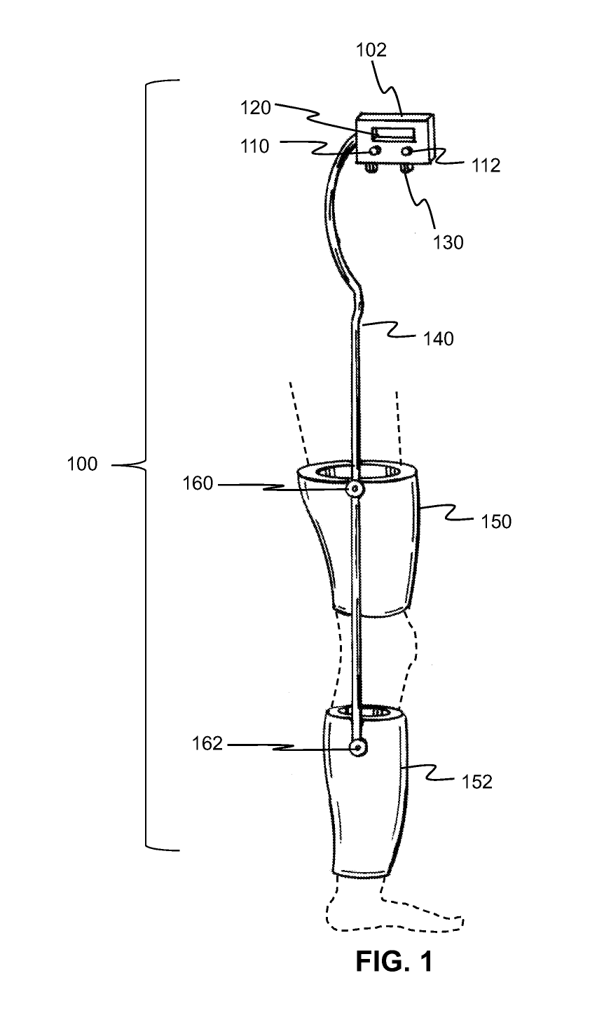

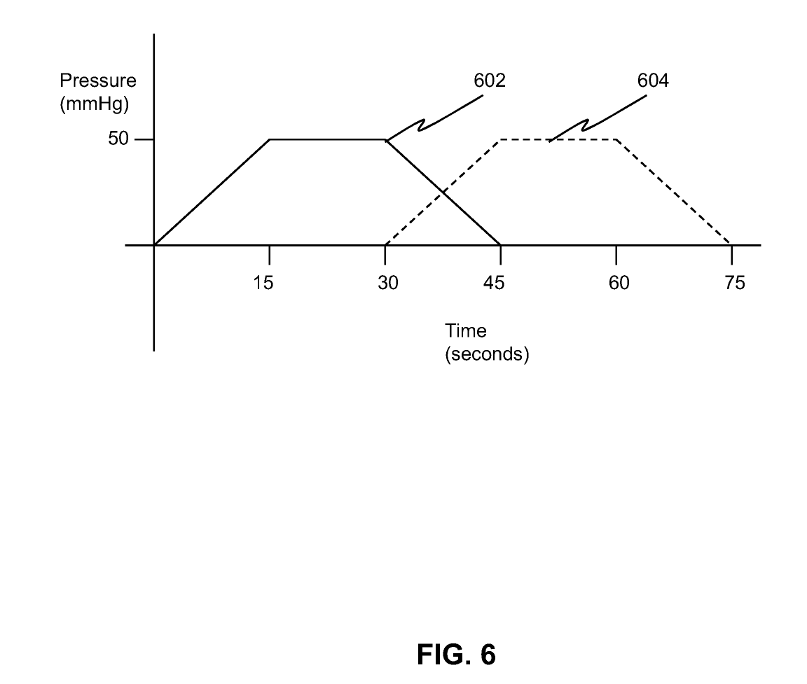

FIG. 1 is an illustration of a perspective view of the leg constriction apparatus 100 for promoting blood circulation, in accordance with one embodiment of the present invention. FIG. 1 shows two cylindrically-shaped inflatable elements 150, 152, similar to the inflatable cuffs used in sphygmomanometers. The first inflatable element 150 surrounds the thigh of a patient's leg 190 and the second inflatable element 152 surrounds the patient's calf. As each inflatable element inflates, circumferential pressure is placed on the corresponding area of the patient's leg 190, thereby pushing blood away from that area of the leg. When executed in a particular fashion (described in greater detail below with reference to FIG. 6), the aforementioned pressure promotes blood circulation in a patient.

FIG. 1 shows that inflatable elements 150, 152 carry a small profile with a slight thickness that easily slip over a patient's leg 190. Further, the inflatable elements 150, 152 are form fit to the shape of a thigh and calf, respectively, thereby reducing the bulkiness associated with clothing that is not contoured to the shape of a wearer's body. The relatively small and inconspicuous nature of the inflatable elements 150, 152 allow a patient to wear the inflatable elements 150, 152 discretely underneath his or her pants or a dress, thereby improving over the prior art. This increases the usability of the present invention, as it eliminates or reduces the possibility that a bystander will notice the apparatus, thereby embarrassing the patient. Further, the small silhouette and the contoured shape of the inflatable elements 150, 152 do not inhibit the wearer's movement. This increases the versatility and use of the present invention as it allows a patient to wear the device when he or she is at work, driving or watching television.

Each inflatable element 150, 152 may either be an uninterrupted cuff that slips over the patient's leg 190 or include a removable seam that allows the cuff to be opened, placed over the leg 190, and closed, such as in a hook-and-loop implementation. Further, the inflatable elements 150, 152, including the inflatable compartments within then, may be manufactured from a man-made material, such as a vinyl polymer.

FIG. 1 further shows one or more tubes 140 that connect the inflatable elements 150, 152 with an air pump in enclosure 102, and which carry the air used to inflate and deflate elements 150, 152. Connector 160 connects the one or more tubes 140 to inflatable element 150 and connector 162 connects the one or more tubes 140 to inflatable element 152. FIG. 1 additionally shows enclosure 102, which houses, among other things, an air pump that pumps air into the inflatable elements 150, 152, an escape valve used for allowing air out of the inflatable elements 150, 152, and a processor that regulates the inflation and deflation processes according to a program, as described with reference to FIG. 6 below.

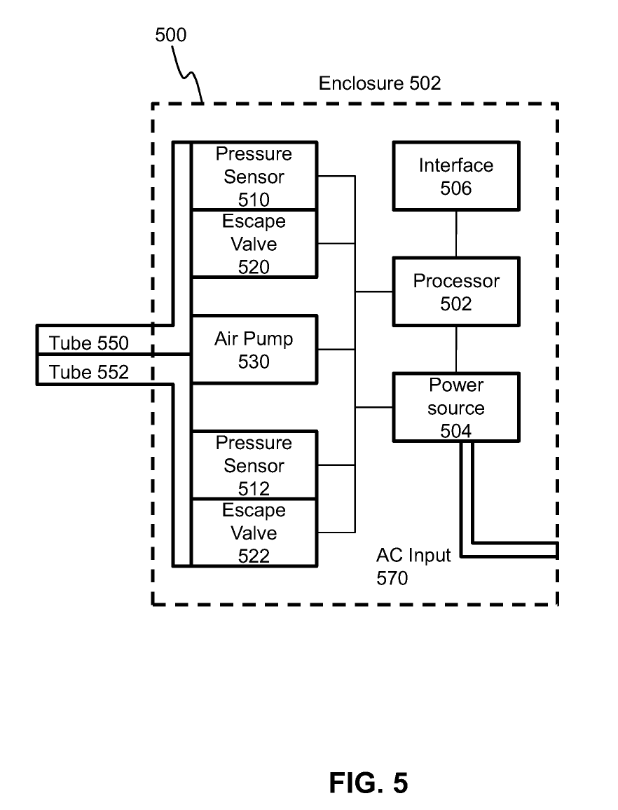

The battery-powered enclosure 102 includes buttons and/or knobs 110, 112, 130 for controlling various features or functions of the apparatus 100. Enclosure 102 further includes a display 120 for displaying various types of information related to features or functions of the apparatus 100. The functions of buttons and/or knobs 110, 112, 130 and display 120 are described in more detail below with reference to FIG. 5. The palm-sized enclosure 102 features a diminutive size, about the size of a pack of cigarettes or a pack of playing cards, thereby allowing for easy concealment. This allows the patient to easily carry the enclosure 102 on his belt, on the waist of his pants or in a pocket, in an improvement over the prior art. If worn on the patient's exterior, the enclosure 102 can be mistaken for a cell phone, an MP3 player or the like, thereby easily disguising the nature of the apparatus. Again, this increases the usability of the present invention, since it reduces the possibility that an onlooker will notice the apparatus, and since its small size does not inhibit the wearer's movement.

Note that although FIG. 1 shows only one pair of inflatable elements 150, 152 that surround one leg, the present invention supports an embodiment that includes two pairs of inflatable elements—one for each of the patient's legs. In this embodiment, the same enclosure 102 can be used to control both pairs of inflatable elements or a separate enclosure may exist to control each of the inflatable elements.

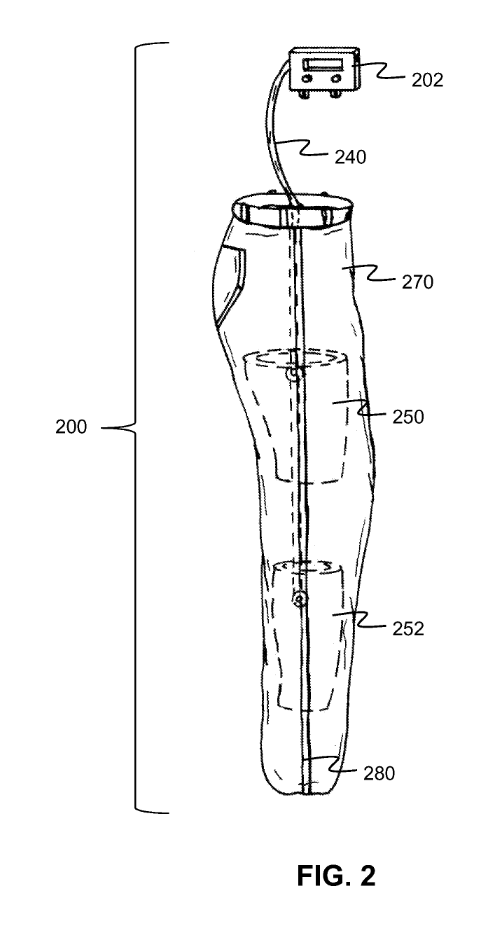

FIG. 2 is an illustration of a perspective view of another embodiment of a leg constriction apparatus 200 for promoting blood circulation, in accordance with one embodiment of the present invention. Embodiment 200 is similar to embodiment 100, except that it is integrated into a pair of pants 270, such as blue jeans. FIG. 2 shows that, like embodiment 100, the apparatus 200 includes an enclosure 202 that regulates the air pressure within inflatable elements 250, 252 via one or more tubes 240.

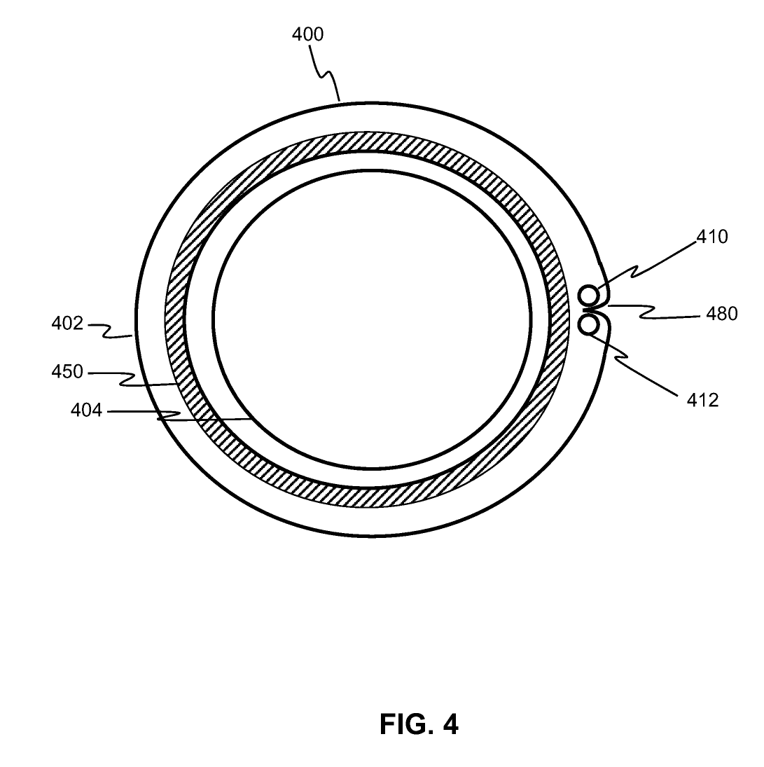

Embodiment 200 requires that inflatable elements 250, 252 are integrated into the pants 270. For example, the inflatable elements 250, 252 and tubes 240 may be stitched to the inside surface of the pants 270 or may be sown in between two separate layers of fabric that comprise the pants 270, as described in greater detail below with reference to FIG. 4. Further, the one or more tubes 240 emanating from enclosure 202 can be positioned to be threaded down the side of the pants 270 behind the exterior seam 280 so as to be hidden by the seam 280. Typically, pants, especially blue jeans, have extra thickness along the exterior seam because two or more layers of fabric come together along the seam to be stitched together. This extra thickness along the exterior seam 280 is used to hide the one or more tubes 240 behind it. Since individuals are used to seeing extra thickness along an exterior seam, the small bulge created by snaking tube 240 behind the seam 280 is negligible and unnoticeable by the casual onlooker.

Again, the inconspicuous nature of the apparatus of embodiment 200 allows a patient to wear the device 200 discretely without disclosing to a passerby that he is wearing a medical device, thereby improving over the prior art. This increases the usability of the present invention, as it eliminates or reduces the possibility that a bystander will notice the apparatus. Further, the integration of the inflatable elements 250, 252 with the pants 270 limits any inhibition of the wearer's movement and reduces the possibility of discomfort of the wearer during use.

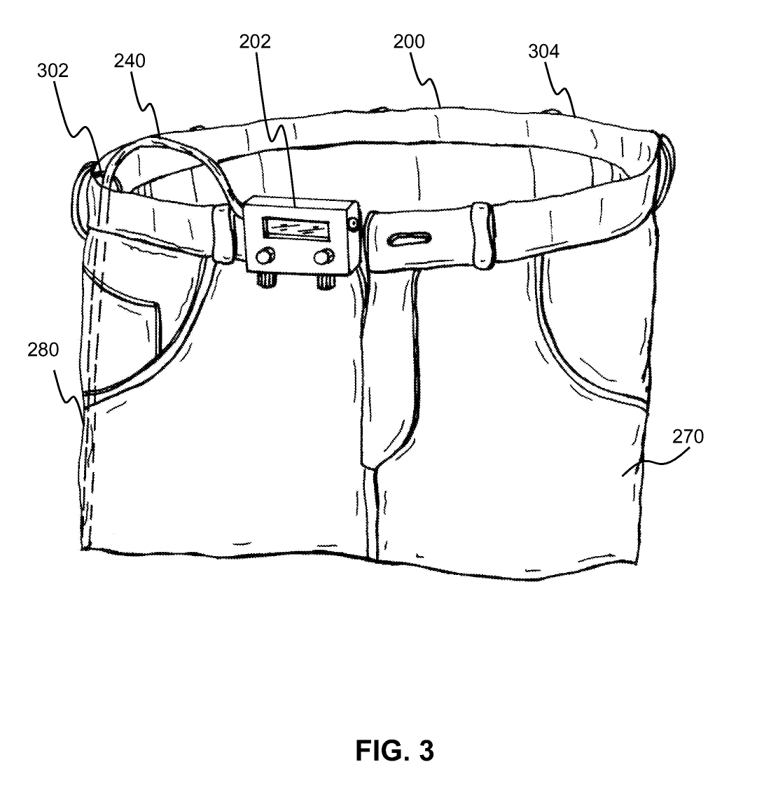

FIG. 3 is an illustration of a more detailed view of the leg constriction apparatus 200 for promoting blood circulation of FIG. 2. In particular, FIG. 3 provides more detail on the enclosure 202 and the ability of the enclosure to be fastened to the wearer's belt or pant waist 304 via a clip or other fastening device, much like a portable radio, MP3 player or cell phone can be worn on a pant waist. FIG. 3 shows that enclosure 202 is attached to a pant waist 304, thereby allowing for easy and comfortable access by the wearer. Further, the enclosure 202 sports an inconspicuous look that could be confused by the casual passerby with a cellular phone, a beeper or a radio. The ease of use of enclosure 202, the easy access provided to it, and its discrete appearance increase the usability of the device 200, thereby improving over the prior art.

FIG. 3 further shows that one or more tubes 240 emanate from enclosure 202 and enter pants 270 via an orifice 302 that provides access to a space within pants 270 in between two layers of fabric. In this manner, tubes 240 are threaded down the side of the pants 270 behind the exterior seam 280 so as to be hidden by the seam 280. The extra thickness along the exterior seam 280 hides the one or more tubes 240 behind it.

FIG. 4 is an illustration of a transverse cross section view of another embodiment of a leg constriction apparatus 400 for promoting blood circulation, in accordance with one embodiment of the present invention. FIG. 4 shows a cross section of inflatable element 450, which corresponds to element 250 of FIG. 2. FIG. 4 further shows interior fabric layer 404 and exterior fabric layer 402, wherein inflatable element 450 and tubes 410, 412 are located in between two separate layers of fabric (to which the element 450 and tubes 410, 412 may be stitched or sown) that comprise pant legs, which correspond to pants 270 of FIG. 2. Tubes 410, 412 carry air to and from inflatable elements, as described in this specification.

FIG. 4 further shows that tubes 410, 412 can be positioned to be threaded down the side of the pants behind the exterior seam 480 so as to be hidden by the seam. Tubes 410, 412 are located between the exterior layer of fabric 402 and inflatable element 450. FIG. 4 shows the extra thickness along the exterior seam 480 because two layers of fabric come together along the seam and are stitched together. The extra thickness along the exterior seam 480 hides the tubes 410, 412 behind it.

FIG. 5 is an illustration of a block diagram of the main electrical and mechanical components of the leg constriction apparatus 500 for promoting blood circulation, in accordance with one embodiment of the present invention. FIG. 5 provides more detail regarding the enclosure 502, which corresponds to enclosure 102 of FIG. 1. FIG. 5 shows that enclosure 502 includes a pressure sensor 510 for measuring the pressure within tube 550 and a pressure sensor 512 for measuring the pressure within tube 552. Tubes 550, 552 carry air to and from inflatable elements, as described in this specification. Further, escape valve 520 is used to allow air to escape from tube 550 while escape valve 522 is used to allow air to escape from tube 552. Air pump 530 pumps air into tubes 550, 552 on command. Processor 502 is communicatively coupled with air pump 530, pressure sensors 510, 512, as well as escape valves 520, 522. Processor 502 controls air pump 530 and escape valves 520, 522 according to stored program logic and reads data from pressure sensors 510, 512 so as to effectuate its program logic.

Power source 504 of enclosure 560 may comprise a rechargeable battery and may also include an AC input channel 570, which allows for direct connection to an electrical outlet for powering the enclosure 502 or recharging the battery, or both. Interface 506 comprises the buttons and/or knobs 110, 112, 130 (see FIG. 1) for controlling various features or functions of the apparatus 500. Interface 506 further comprises the display 120 for displaying various types of information related to features or functions of the apparatus 100. In one embodiment, buttons 110, 112 are used by the patient to control various functions such as switching the device 500 on and off, choosing certain maximum pressures to which the inflatable elements are inflated (such as 30 mmHg or 50 mmHg) and/or choosing a time period for inflating the inflatable elements.

FIG. 6 is an illustration of a graph that charts pressure versus time with regard to the process of the leg constriction apparatus 100 for promoting blood circulation, in accordance with one embodiment of the present invention. FIG. 6 shows the air pressure within inflatable elements 150, 152 over time, as the inflatable elements 150, 152 are inflated and deflated according to program logic executed by processor 502 in enclosure 102. The line 602 corresponds to inflatable element 152 while line 604 corresponds to inflatable element 150.

FIG. 6 shows that inflatable element 152 is inflated at a steady pace for 15 seconds until a maximum predefined pressure is reached, which may be between 30 mmHg and 50 mmHg. This causes blood in the patient's calf to be pushed upwards towards the patient's thigh. Then, this pressure is held for 15 seconds in element 152, after which the inflatable element 152 is deflated at a steady pace at the same time that inflatable element 150 is inflated at a steady pace for 15 seconds. Inflatable element 150 is inflated at a steady pace until a maximum predefined pressure is reached. This causes blood in the patient's thigh to be pushed upwards towards the patient's torso. Then, this pressure is held for 15 seconds, after which the inflatable element 150 is deflated at a steady pace for 15 seconds. This cycle can be repeated as many times as is necessary with a pause, such as 15 seconds, in between each cycle.

It should be noted that the program described above can be encompassed in a computer program logic executed by processor 502. Inflation of an inflatable element is accomplished by the processor 502 by activating the pump 530 to pump air into the appropriate tube 550, 552 that corresponds to the inflatable element to be inflated. The corresponding inflatable element is inflated up to a predefined maximum air pressure that may have been selected by the patient using interface 506. The processor 502 checks the corresponding pressure sensor 510, 512 to determine when the air pressure within the corresponding tube 550, 552 (and therefore also the corresponding inflatable element) has reached the intended maximum pressure. When the intended maximum pressure has been reached, inflation stops. Deflation of an inflatable element is accomplished by the processor 502 by activating the escape valve that corresponds to the inflatable element to be deflated.

It should further be noted that computer program logic encompassing instructions for inflating and deflating inflatable elements 150, 152 can be stored in enclosure 502 in volatile or non-volatile memory for reading by processor 502. Various types of inflation-deflation programs—that vary inflation limits, time periods and number of cycles—can be stored in enclosure 502 depending on the needs of the patient. Programs can be pre-loaded in enclosure 502 or uploaded at a later time by the patient or an administrator.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

1. A mobile leg constriction apparatus for promoting blood circulation, comprising:
a first cylindrically-shaped inflatable element for surrounding a patient's thigh;
a second cylindrically-shaped inflatable element for surrounding the patient's calf;
a first tube for connecting the first inflatable element to an air pump;
a second tube for connecting the second inflatable element to the air pump;
a palm-sized enclosure comprising:
an air pump for inflating the first and second inflatable elements up to a predefined maximum pressure, wherein the air pump is coupled to the first and second tubes;
one or more pressure sensors for measuring air pressure within the first and second tubes;
one or more escape valves for allowing air to escape from the first and second tubes;
a processor communicatively coupled to the air pump, the one or more pressure sensors and the one or more escape valves, and configured for receiving information from the one or more pressure sensors and initiating inflation and deflation of the first and second inflatable elements according to a predefined profile.

2. The apparatus of claim 1, wherein the processor is further configured for:
activating the air pump to inflate the second inflatable element;
reading information from the one or more pressure sensors to determine the pressure within the second tube;
halting inflation of the second inflatable element when the information received from the one or more pressure sensors indicates the pressure within the second tube has reached a predefined maximum pressure; and
pausing for a predefined time period.

3. The apparatus of claim 2, wherein the processor is further configured for:
activating the one or more escape valves for allowing air to escape from the second tube and simultaneously activating the air pump to inflate the first inflatable element;
reading information from the one or more pressure sensors to determine the pressure within the first tube;
halting inflation of the first inflatable element when the information received from the one or more pressure sensors indicates the pressure within the first tube has reached the predefined maximum pressure; and
pausing for a predefined time period.

4. The apparatus of claim 3, wherein the processor is further configured for:
activating the one or more escape valves for allowing air to escape from the first tube; and
pausing for a predefined time period.

5. A mobile leg constriction apparatus for promoting blood circulation, comprising:
a pair of pants having a first and second pant leg and wherein each pant leg includes a thigh portion and a calf portion;
a first cylindrically-shaped inflatable element coupled to an interior of the thigh portion of a first pant leg, wherein the first inflatable element surrounds a patient's thigh;
a second cylindrically-shaped inflatable element coupled to an interior of the calf portion of the first pant leg, wherein the second inflatable element surrounds the patient's calf;
a first tube for connecting the first inflatable element to an air pump, wherein the first tube is located behind an exterior seam of the pair of pants;
a second tube for connecting the second inflatable element to the air pump, wherein the second tube is located behind an exterior seam of the pair of pants;
a palm-sized enclosure comprising:
an air pump for inflating the first and second inflatable elements up to a predefined maximum pressure, wherein the air pump is coupled to the first and second tubes;
one or more pressure sensors for measuring air pressure within the first and second tubes;
one or more escape valves for allowing air to escape from the first and second tubes;
a processor communicatively coupled to the air pump, the one or more pressure sensors and the one or more escape valves, and configured for receiving information from the one or more pressure sensors and initiating the inflation and deflation of the first and second inflatable elements according to a predefined profile.

6. The apparatus of claim 5, wherein the processor is further configured for:
activating the air pump to inflate the second inflatable element;
reading information from the one or more pressure sensors to determine the pressure within the second tube;
halting inflation of the second inflatable element when the information received from the one or more pressure sensors indicates the pressure within the second tube has reached a predefined maximum pressure; and
pausing for a predefined time period.

7. The apparatus of claim 6, wherein the processor is further configured for:
activating the one or more escape valves for allowing air to escape from the second tube and simultaneously activating the air pump to inflate the first inflatable element;
reading information from the one or more pressure sensors to determine the pressure within the first tube;
halting inflation of the first inflatable element when the information received from the one or more pressure sensors indicates the pressure within the first tube has reached the predefined maximum pressure; and
pausing for a predefined time period.

8. The apparatus of claim 7, wherein the processor is further configured for:
activating the one or more escape valves for allowing air to escape from the first tube; and
pausing for a predefined time period.

9. The apparatus of claim 5, further comprising a fastener for fastening the enclosure to a waist of the pair of pants.

10. A mobile leg constriction apparatus for promoting blood circulation, comprising:
a first cylindrically-shaped inflatable element for surrounding a patient's thigh;
a second cylindrically-shaped inflatable element for surrounding the patient's calf;
a first tube for connecting the first inflatable element to an air pump;
a second tube for connecting the second inflatable element to the air pump;
a palm-sized enclosure comprising:
an air pump for inflating the first and second inflatable elements up to a predefined maximum pressure, wherein the air pump is coupled to the first and second tubes;
one or more pressure sensors for measuring air pressure within the first and second tubes;
one or more escape valves for allowing air to escape from the first and second tubes;
a processor communicatively coupled to the air pump, the one or more pressure sensors and the one or more escape valves, and configured for:
activating the air pump to inflate the second inflatable element;
reading information from the one or more pressure sensors to determine the pressure within the second tube;
halting inflation of the second inflatable element when the information received from the one or more pressure sensors indicates the pressure within the second tube has reached a predefined maximum pressure;
pausing for a predefined time period.
activating the one or more escape valves for allowing air to escape from the second tube and simultaneously activating the air pump to inflate the first inflatable element;
reading information from the one or more pressure sensors to determine the pressure within the first tube;
halting inflation of the first inflatable element when the information received from the one or more pressure sensors indicates the pressure within the first tube has reached the predefined maximum pressure;
pausing for a predefined time period.
activating the one or more escape valves for allowing air to escape from the first tube.
